(19) United States
(12) Patent Application Publication
(10) Pub. No.: US 2015/0340153 A1
(43) Pub. Date: Nov. 26, 2015

(54) INDUCTIVE CHARGING COIL DEVICE

(71) Applicant: ROBERT BOSCH GMBH, Stuttgart (DE)

(72) Inventors: Guenter Lohr, Leinfelden-Echterdingen (DE); Dragan Krupezevic, Stuttgart (DE); Juergen Mack, Goeppingen (DE); Marcin Rejman, Waiblingen (DE)

(21) Appl. No.: 14/653,110

(22) PCT Filed: Dec. 18, 2013
(86) PCT No.: PCT/EP2013/077148

§ 371 Date: Jun. 17, 2015

(30) Foreign Application Priority Data
Dec. 21, 2012 (DE) 10 2012 112 838.3
Dec. 21, 2012 (DE) 10 2012 112 846.4
Dec. 21, 2012 (DE) 10 2012 112 865.0
Dec. 21, 2012 (DE) 10 2012 112 877.4
Dec. 17, 2013 (DE) 10 2013 226 228.0

(51) Int. Cl. H01F 38/14; H01F 27/28

(52) U.S. Cl. CPC H01F 38/14; H01F 27/2804; H01F 2027/2809

(57) ABSTRACT

An inductive charging coil device, in particular a hand-held power tool inductive charging coil device, includes at least one coil unit having at least one conductor. It is provided that the conductor includes at least two main cross sections.

### FIELD OF THE INVENTION

The present invention is directed to an inductive charging coil device, in particular a hand-held power tool inductive charging coil device, including at least one coil unit.

### BACKGROUND INFORMATION

At least certain inductive charging coil devices, in particular hand-held power tool inductive charging coil devices, including at least one coil unit are believed to be already understood.

### SUMMARY OF THE INVENTION

The present invention is directed to an inductive charging coil device, in particular a hand-held power tool inductive charging coil device, including at least one coil unit.

It is provided that the coil unit has at least one conductor including at least two main cross sections, which are situated in parallel according to line technology. A “coil unit” is to be understood in this context in particular as a unit which has at least one conductor loop including at least one winding formed by a conductor. The coil unit is provided to transmit and/or to receive electrical energy in at least one operating state. The coil unit may have a winding support. The winding support may be provided in particular to support the at least one conductor loop. The coil unit may be provided to supply received energy, in particular via a voltage transformer and/or charging electronics, to a consumer and/or a rechargeable battery unit. Alternatively, the inductive charging coil device may be provided to transmit energy to a further inductive charging coil device. The coil unit may be provided to convert an electric alternating current into a magnetic alternating field and/or vice versa. The alternating field may have a frequency of 10 kHz-500 kHz, particularly 100 kHz-120 kHz. A “hand-held power tool inductive charging coil device” is to be understood in this context in particular as an inductive charging coil device of a handheld power tool, a handheld power tool rechargeable battery, or a handheld power tool rechargeable battery charging device. A “handheld power tool” is to be understood in this context as an electrical device which is hand-operated by a user, such as, in particular, a power drill, a drill hammer, a saw, a plane, a screwdriver, a milling tool, a grinder, an angle grinder, and/or a multifunction tool, or a garden tool such as a hedge trimmer, and shrub and/or grass shears. A “main cross section” is to be understood in this context in particular as areas of a conductor cross section, which is formed by an electrically conductive material, having increased thickness in relation to areas between the main cross sections.

A “thickness” is to be understood in this context in particular as a direction perpendicular to a spacing of main cross sections. An “increased” thickness is to be understood in this context as at least an increase by 50%, which may be 75%, particularly more than 90%. The main cross sections may be situated in parallel according to line technology. The main cross sections may extend along a predominant part of a conductor length, particularly along more than 90% of the conductor length. “In parallel according to line technology” is to be understood in this context in particular as connected in parallel according to circuit technology. The main cross sections of the conductor may have a shared winding direction. The main cross sections of the conductor may be situated adjacent to one another, in relation to a winding radius around a winding axis, in the area of the conductor loop. A material cross section of the conductor required for a desired electrical resistance of the coil unit may advantageously be allocated to the main cross sections situated in parallel according to line technology. In particular, a material cross section of a main cross section of the conductor, in particular in the direction of the winding radius, may be less than a material cross section of a main cross section of a coil unit, the winding of which is formed by a conductor having a single main cross section. A surface of the conductor may be enlarged in relation to a conductor having a single main cross section with an equal overall cross section.

A “surface” of the conductor is to be understood in this context in particular as a surface of the conductive material of the conductor. Eddy current losses in the conductor may be effectively reduced. A skin effect may be less in the case of a conductor which has multiple main cross sections. A “skin effect” is to be understood in this context in particular to mean that, in the case of a conductor through which a high-frequency alternating current flows, a current density is higher on the surface of the conductor than in its interior. Electrical losses may be reduced. Heating of the coil unit may be reduced. A degree of efficiency may advantageously be increased.

It is provided that the conductor includes at least three main cross sections. Cross-sectional areas of the individual main cross sections may be reduced further. The surface of the conductor may be enlarged further. Electrical losses may be particularly low. A degree of efficiency of the inductive charging coil device may be particularly high.

Furthermore, it is provided that adjacent main cross sections of the at least one conductor are situated touching one another and/or adjacent main cross sections of the at least one conductor are connected to one another. “Touching” is to be understood in this context in particular to mean that surfaces of the main cross sections touch one another between adjacent main cross sections in such a way that an electrical contact exists between the main cross sections. “Connected” is to be understood in this context in particular to mean that the main cross sections have an integrally joined connection in particular. The integrally joined connection may have a reduced thickness in relation to the thickness of the main cross section, in particular a thickness reduced by more than 50%, which may be more than 80%. The main cross sections may be situated in a particularly space-saving way. The conductor may have a particularly large overall cross section.

The main cross sections may be electrically insulated from one another in the area of the conductor loop. “Insulated” may be to be understood in this context as a resistance between the main cross sections in the area of the conductor loop of greater than 1 kiloohm. In particular, adjacent main cross sections may be situated at a distance to one another. The entire surface of the conductor may be particularly large. A current flow between the main cross sections may be prevented. Losses of the inductive charging coil device may be reduced further.

Furthermore, an insulator is provided, which is situated at least partially between adjacent main cross sections of the conductor. An “insulator” is to be understood in particular as a material having an electrical conductivity of less than 10⁻³ S/m, which may be less than 10⁻⁸ S/m (Siemens/meter). In particular, the insulator may have an air layer and/or at least one lacquer layer. A current flow between main cross sections of the conductor may be effectively reduced in the area of the winding. Losses of the inductive charging coil device may be further reduced.

In one advantageous implementation of the present invention, it is provided that the coil unit is at least partially formed by printed conductors of at least one conductor layer of a circuit board. The circuit board may include at least one electrically insulating carrier layer and at least one conductor layer, which adheres to, the carrier layer. The carrier layer may be formed by a flexible film or a rigid material, such as a plastic, in particular a fiber-reinforced plastic. Further materials known to those skilled in the art are also possible. The conductor layer may be formed by a copper alloy or another electrically conductive material, in particular a metal. Printed conductors of the conductor layer may form main cross sections of the conductor of at least one winding of the coil unit. Winding of the winding of the coil unit may be omitted. A winding support, around which windings of the coil unit are wound, may be omitted. The carrier layer of the circuit board may support the windings.

The carrier layer of the circuit board may fulfill the function of a winding support of the coil unit. A thickness of the coil unit in the direction of the winding axis may be particularly small. The coil unit may be manufactured particularly cost-effectively. The carrier layer of the circuit board may support the main cross sections of the conductor particularly well. The coil unit may be particularly robust. The coil unit is particularly advantageously at least partially situated on two conductor layers of the circuit board. In particular, the coil unit may be at least partially situated on two opposing sides of the at least one carrier layer of the circuit board. Conductor layers, which form conductor loops of the coil unit, may be situated on the opposing sides of the carrier layer. It is also possible that multiple conductor layers, which are separated by an insulation layer, are situated on one side of a carrier layer. The circuit board particularly advantageously has a multilayered structure including a plurality of carrier layers. Conductor layers may be situated on each of the carrier layers on one side and/or on both sides. It is also possible that multiple conductor layers are situated, separated by insulation layers, on one side of a carrier layer. A particularly large number of conductor layers may be available.

The conductor loops of the coil unit may be situated particularly flexibly. The inductive charging coil device may have a particularly large number of conductor loops. The conductor loops may have a particularly large number of windings in total. It is provided that the coil unit includes at least three conductor loops. The conductor loops may be situated on at least three sides of carrier layers of the circuit board. A double-layer circuit board having two carrier layers may have conductor loops on three sides of the carrier layers, and may have printed conductors on a fourth side, which are provided for further applications, in particular for accommodating and/or connecting electrical and/or electronic components.

The conductor loops may have windings having the same winding direction. A “winding direction” is to be understood in this context in particular as a winding direction around the winding axis. The conductor loops of the coil unit may have, electromagnetically, at least essentially the properties of a coil including a continuous conductor loop having a number of windings which corresponds to the total of the numbers of windings of the conductor loops of the coil unit. A number of windings required for the coil unit may advantageously be situated on multiple conductor layers. A number of windings of the individual conductor loops may be reduced.

It is provided that the circuit board includes at least one feedthrough, through which at least one connecting lead of the coil unit is led. The connecting lead may connect at least two conductor loops of the coil unit. The connecting lead may be led through a recess of at least one carrier layer of the circuit board. The conductor loops may be effectively electrically connected.

A number of windings of two conductor loops may be odd in total. The number of windings of two conductor loops situated on a carrier layer is particularly odd in total. A winding may be allocated to the two conductor loops. The two conductor loops may each have a half winding. The two ends of the conductor loops connected by the connecting lead may advantageously be situated spatially separated from the further, free ends of the conductor loops. The ends connected by the connecting lead may be situated on the circuit board opposite the further ends in relation to the winding axis.

An at least largely congruent arrangement of the terminal areas of the coil unit may be provided in a thickness direction of the circuit board. “Terminal areas” of the coil unit are to be understood as areas which accommodate a terminal arrangement, which are provided for electrically contacting the conductor loops. The terminal areas may be connected to the free ends of the conductor loops. “Free ends” are to be understood in this context as the ends of the conductor loops, which form the beginning and/or the end of the coil of the coil unit formed by the conductor loops. In particular, a contact arrangement, such as plug connectors and/or solder surfaces in particular, may be provided in the terminal areas. The terminal arrangement may particularly advantageously be situated. A structure of the inductive charging coil device may be particularly simple.

Furthermore, it is provided that the inductive charging coil device has an electronics unit and/or a core unit and a contacting unit for contacting the coil unit, and the contacting unit is led through a recess of the electronics unit and/or the core unit. An “electronics unit” is to be understood in this context in particular as a device which includes at least one electrical and/or electronic component. The electronics unit may have a circuit board in particular. A “core unit” is to be understood in this context in particular as a device which is provided to focus an electromagnetic field. In particular, the core unit may be at least partially formed by a magnetic material. A “magnetic material” is to be understood in this context in particular as a ferromagnetic, in particular a magnetically soft, material. Alternatively, it is also conceivable to use ferromagnetic and/or antiferromagnetic materials. In particular, the magnetic material may be formed by a ferrite material. A “ferrite” is to be understood in this context in particular as a material which is formed at least 70%, advantageously at least 80%, which may be at least 90%, from iron oxide (Fe₂O₃ and/or Fe₃O₄).

The magnetic material may have a relative permeability μ greater than 100, which may be greater than 1000, particularly greater than 5000. The core unit may be a sintered component. The core unit may be a composite component. In particular, the core unit may be a composite component which is formed by a matrix material, in which elements made of the magnetic material are embedded. The elements may be formed by a ceramic, in particular ferromagnetic material, whereby a particularly high degree of efficiency may advantageously be achieved during an energy transfer. In particular, a “ceramic” material is to be understood as an inorganic polycrystalline material, which was produced by a sintering process. The core unit may be at least partially situated between the electronics unit and the coil unit. A “contacting unit” may be to be understood in this context as a device which is provided for detachable contacting of the coil unit. In particular, the contacting unit may be implemented as a plug connection including two plug connection elements. The plug connection may have a plug and a coupling. However, alternative implementations of the contacting unit are also conceivable, in particular supply lines, which establish a contact with the aid of a soldered joint. One of the plug connection elements, which may be the plug, may be permanently connected to the coil unit. The plug connection element may be soldered to the coil unit.

The further plug connection element may be connected to the electronics unit, which may be soldered. The further plug connection element may be implemented as a coupling. In an installed state of the inductive charging coil device, in which the contacting unit contacts the coil unit including the electronics unit, the plug connection elements may be situated at least in large part inside the recesses of the core unit and/or the electronics unit. “In large part” is to be understood in this context as more than 50%, which may be more than 60%, particularly more than 80% of an external volume of the plug connection. The inductive charging coil device may be particularly compact. In particular, the inductive charging coil device may be particularly thin in a thickness direction in the direction of a winding axis. Particularly space-saving housing of the inductive charging coil device may be possible. A device including the inductive charging coil device may be particularly compact. Assembly of the inductive charging coil device may be particularly simple. In particular, the contacting unit may form the contacting of the coil unit with the electronics unit when the coil unit is joined together with the core unit and the electronics unit in one assembly motion.

Furthermore, it is provided that the coil unit includes at least one winding having a winding shape deviating from a circular shape. A “winding shape” is to be understood in this context in particular as the shape of an averaged winding path of the windings of a conductor loop. “Deviating from a circular shape” is to be understood in this context in particular as a winding shape deviating from a circular shape, in which a length of the winding path is at least 10% longer, which may be more than 20% longer, particularly more than 30% longer than a circumference of a largest circle inscribed in the winding path. In particular, the winding shape may be adapted to a shape of an installation space of a housing, in which the inductive charging coil device is situated. The inductive charging coil device may utilize an installation space particularly well. The inductive charging coil device may be particularly powerful. An electrical energy of the coil unit may be particularly high.

It is provided that at least one conductor loop has a winding shape at least approximating a rectangle. “At least approximating a rectangle” is to be understood in this context in particular to mean that the winding path, along more than 50%, which may be more than 75% of its circumference, deviates from a rectangle by less than 10%, which may be less than 5% with respect to a smallest winding diameter. Corners of the winding shape of the conductor loop may have a radius. The winding shape of the conductor loop may particularly approximate a square. In addition to square and rectangular winding shapes, further winding shapes are also conceivable, in particular an elliptical winding shape. The inductive charging coil device may be adapted particularly flexibly to an existing installation space. The coil unit may emit and/or receive electromagnetic fields, which deviate from a circular symmetry, particularly well. A degree of efficiency and/or a performance of the inductive charging coil device may be dependent on an alignment. The degree of efficiency and/or the performance of the inductive charging coil device may be adjustable.

Furthermore, a coil bearing unit is provided, which is provided to rotatably support at least one coil unit around at least one axis. The coil bearing unit may be provided to rotatably support the at least one coil unit around its winding axis. It is also possible that the coil bearing unit rotatably supports the inductive charging coil device. In particular, the coil bearing unit may rotatably support the inductive charging coil device on a housing unit, in particular on a housing unit of a handheld power tool or a hand-held power tool rechargeable battery pack. An orientation of the coil unit may advantageously be adapted to an orientation of a coil unit of a further inductive charging coil device. In particular, the orientation of the coil unit may be varied, while a handheld power tool and/or a hand-held power tool rechargeable battery pack, which contain(s) the coil unit, remain(s) stationary.

Furthermore, an alignment unit is provided, which is provided to align the coil unit in an orientation around at least one axis. The alignment unit may be provided to align the coil unit in its orientation around its winding axis. The alignment unit may be in particular a device which at least partially carries out an automatic alignment of the coil unit. The alignment may be carried out in accordance with a defined alignment, in particular in accordance with an alignment of a further inductive charging coil device. The alignment may be dependent on a performance capacity of the inductive charging coil device, in particular, the alignment may be carried out in such a way that an electrical energy and/or a degree of efficiency of the inductive charging coil device reach(es) a desired value, in particular is/are maximized. The alignment unit may contain in particular at least one active alignment arrangement, such as an actuator in particular. The alignment unit may contain a mechanical alignment arrangement, in particular an arrangement for an alignment with the aid of a form fit, for example, guides and/or links. The coil unit may advantageously be aligned particularly effectively.

The inductive charging coil device particularly advantageously has a display unit, which is provided in at least one operating state to signal a quality of an alignment of the coil unit around the axis to a user. In particular, the display unit may be provided to signal the quality of an alignment of the coil unit around its winding axis to the user. The display unit may in particular have a signaling arrangement, such as lamps and/or LEDs, which indicate the quality of the alignment in color and/or symbolically. In particular, the display unit may signal a good and/or sufficient alignment, in particular by a green signal color and/or a pictogram. The display unit may indicate an imprecise and/or in particular unsuitable alignment by a yellow or red signal color and/or a pictogram. Graphic and/or numeric displays are also conceivable, which indicate the quality of the alignment as a percentage of an optimal alignment, for example. Acoustic displays and further forms of a display of the alignment, which appear reasonable to those skilled in the art, are also conceivable.

Furthermore, an electronics unit and/or a cell unit and a shielding unit, which is situated between the coil unit and the electronics unit and/or the cell unit, are provided, which has an electrically conductive material layer having a projection area which, in the case of a projection in the direction of the winding axis of the coil unit, at least essentially covers the electronics unit and/or the cell unit. An “electronics unit” is to be understood in this context in particular as a device which includes at least one electrical and/or electronic component. In particular, the electronics unit may have a circuit board. The charging electronics may be part of the electronics unit. A “cell unit” is to be understood in this context in particular as an energy storage unit, which includes at least one rechargeable battery cell, which is provided in particular for electrochemical storage of electrical energy. The rechargeable battery cell may be a lead rechargeable battery cell, a NiCd rechargeable battery cell, a NiMh rechargeable battery cell, but in particular a lithium-based rechargeable battery cell. Further types of rechargeable battery cells known to those skilled in the art are also conceivable.

“Shielding” is to be understood in this context in particular as a reduction of an electromagnetic alternating field, which propagates in the direction from the coil unit toward the assembly to be shielded, in the area of the shielded assembly. The electromagnetic alternating field may be reduced by at least 50%, particularly by at least 80%. The electromagnetic alternating field may be caused by operation of the inductive charging coil device. A “projection area” is to be understood in this context in particular as an area of a shadow casting of a body in the case of a parallel projection in the projection direction. “At least essentially cover” is to be understood in this context in particular to mean that the projection area of the shielding unit in the projection direction covers an outer contour of the electronics unit and/or cell unit, which may be the electronics unit and the cell unit, by at least 90%, which may be by more than 95%, particularly by at least 100%. The electrically conductive material layer may shield the electromagnetic field in particular by reflecting and retroreflecting it. The electronics unit and/or the cell unit to be shielded may be protected from the electromagnetic field.

An influence of the electromagnetic field on the electronics unit and/or the cell unit may be reduced. Leakage currents, which are induced by the electromagnetic alternating field in the electronics unit and/or the cell unit, may be reduced. Heating of the electronics unit and/or the cell unit by leakage currents may be reduced. Damage to the electronics unit and/or the cell unit and/or a reduced service life of the electronics unit and/or the cell unit and/or a malfunction of the electronics unit and/or the cell unit due to influences of the electromagnetic alternating field on the electronics unit and/or the cell unit may be prevented. A degree of efficiency of the inductive charging coil device may be increased.

In an alternative embodiment of the present invention, a core unit is provided, the projection area of which, in the case of a projection in the direction of a winding axis of the coil unit, at least essentially covers the electronics unit and/or the cell unit. The core unit may focus field lines of the electromagnetic alternating field and concentrate them in the area of the coil unit and/or deflect them in the direction of a further inductive charging coil device. Energy contained in the electromagnetic alternating field may be at least partially absorbed by the coil unit and strengthen an electrical current. The core unit may shield the electronics unit and/or the cell unit from the electromagnetic field as a shielding unit. The core unit may have the mentioned advantages of a shielding unit.

Furthermore, a hand-held power tool device including an inductive charging coil device including the described features is provided. In this case, the hand-held power tool device may be formed by a handheld power tool, a hand-held power tool rechargeable battery pack, a hand-held power tool case, or by a hand-held power tool rechargeable battery charging device. The hand-held power tool device may have the mentioned advantages of the inductive charging device.

Further advantages result from the following description of the drawings. Seven exemplary embodiments of the present invention are shown in the drawings. The drawings, the description, and the claims contain numerous features in combination. Those skilled in the art will advantageously also consider the features individually and combine them to form reasonable further combinations.

### BRIEF DESCRIPTION OF THE DRAWINGS

FIG. 1 shows a schematic view of a coil unit of an inductive charging coil device.

FIG. 2 shows a schematic view of a hand-held power tool rechargeable battery charging device and a hand-held power tool rechargeable battery pack including inductive charging coil devices according to the present invention.

FIG. 3 shows a schematic view of a section through the inductive charging coil device of the hand-held power tool rechargeable battery pack.

FIG. 4 shows a schematic view of a hand-held power tool rechargeable battery pack including an inductive charging coil device in a second exemplary embodiment.

FIG. 5 shows a schematic view of a coil unit of an inductive charging coil device in a third exemplary embodiment.

FIG. 6 shows a schematic sectional view of a hand-held power tool rechargeable battery pack including the inductive charging coil device of the third exemplary embodiment and a hand-held power tool rechargeable battery charging device including a further inductive charging coil device.

FIG. 7 shows a schematic sectional view of the coil unit of the hand-held power tool rechargeable battery pack in a second sectional plane.

FIG. 8 shows schematic views of further possible winding shapes.

FIG. 9 shows a schematic view of a system including two inductive charging coil devices in a fourth exemplary embodiment.

FIG. 10 shows a schematic view of a hand-held power tool rechargeable battery pack including an inductive charging coil device in a fifth exemplary embodiment.

FIG. 11 shows a schematic sectional view of a coil unit of an inductive charging coil device in a sixth exemplary embodiment.

FIG. 12 shows a schematic view of possible main cross sections of a conductor of further coil units of further inductive charging coil devices.

### DETAILED DESCRIPTION

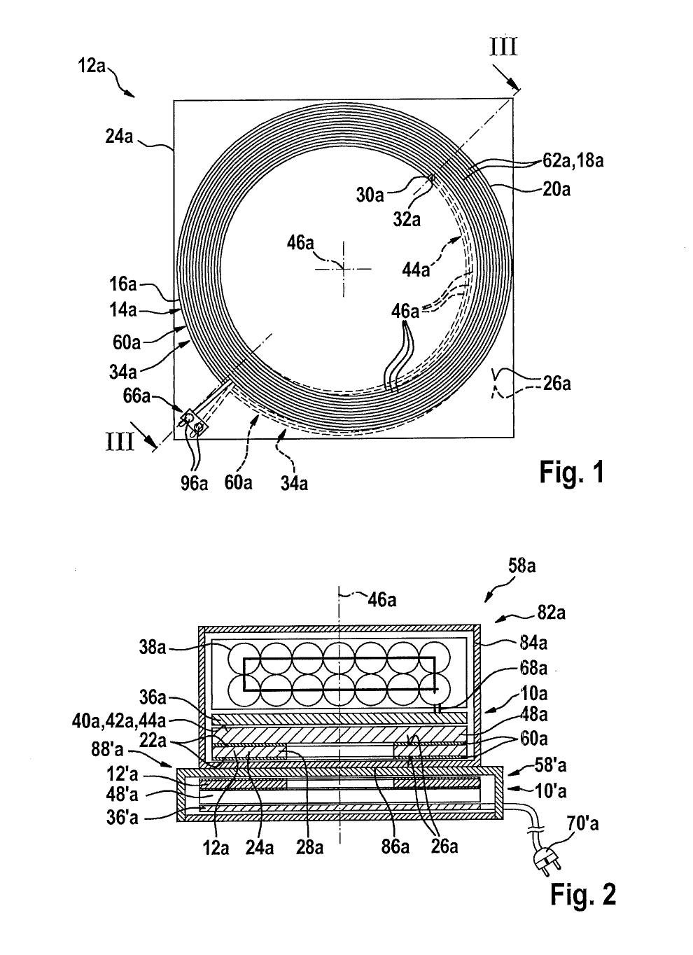

FIG. 1 shows a coil unit 12a of an inductive charging coil device 10a including two conductor loops 60a, each having a spiral-shaped winding 34a. Coil unit 12a is formed by a rectangular circuit board 24a (FIG. 2). Circuit board 24a has conductor layers 22a, which form printed conductors 20a. Printed conductors 20a form windings 34a of coil unit 12a (FIG. 2). Conductor layers 22a are situated on two sides 26a of a carrier layer 28a of circuit board 24a. Carrier layer 28a of circuit board 24a thus fulfills the function of a winding support of windings 34a of coil unit 12a. Windings 34a each have a conductor 14a having three main cross sections 16a. Main cross sections 16a are situated in parallel according to line technology and are formed by printed conductors 20a. Intermediate spaces 62a in the direction of a radius around a winding axis 46a between adjacent main cross sections 16a form insulators 18a. Main cross sections 16a are additionally insulated and sealed using a lacquer layer (not shown in greater detail).

Main cross sections 16a end after 4% windings around winding axis 46a in a terminal area 66a, in relation to winding axis 46a, on opposing sides of circuit board 24a. A connecting lead 32a, which is connected to main cross sections 16a, is led through a feedthrough 30a of circuit board 24a. Connecting lead 32a connects windings 34a on the two sides 26a of circuit board 24a. Windings 34a have the same winding direction around winding axis 46a. Both conductor loops 60a have the same number of windings of 4% windings, so that coil unit 12a has an odd number of windings of 9. Since each conductor loop 60a has a half winding and feedthrough 30a is opposite terminal area 66a, both windings 34a end in the area of terminal area 66a, which is situated on the two sides 26a of circuit board 24a. Due to the three main cross sections 16a, which are situated in parallel to one another according to line technology, conductor loop 60a only has low eddy current losses when a high-frequency current flows through main cross sections 16a.

Inductive charging coil device 10a is an integral part of a hand-held power tool device 58a (FIG. 2). Hand-held power tool device 58a is implemented as a hand-held power tool rechargeable battery pack 82a. A cell unit 38a, which is provided to supply a handheld power tool with energy, is situated in a housing unit 84a. Inductive charging coil device 10a is provided for wireless energy transfer for a charging operation of cell unit 38a. Inductive charging coil device 10a is situated between cell unit 38a and a housing wall 86a of housing unit 84a. Proceeding from housing wall 86a in the direction of cell unit 38a, coil unit 12a, a core unit 48a, and an electronics unit 36a first follow. Electronics unit 36a is connected with the aid of a connecting lead 68a to cell unit 38a and contains charging electronics, which are provided to charge cell unit 38a.

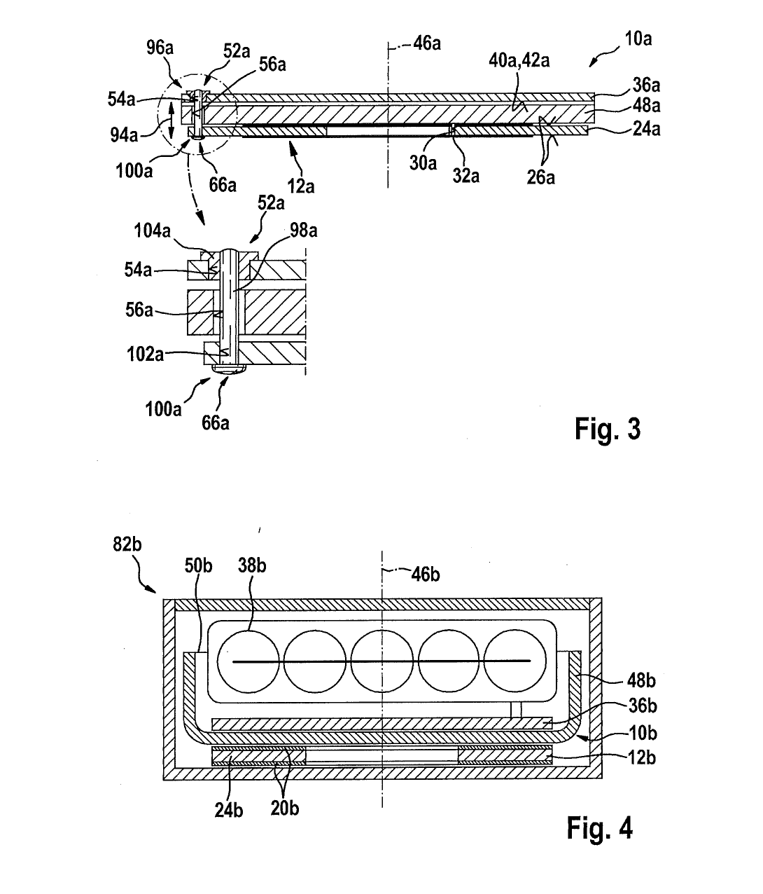

A contacting unit 52a (FIG. 3), which is led through recesses 54a, 56a of electronics unit 36a and core unit 48a, connects electronics unit 36a and coil unit 12a. Contacting unit 52a has a plug 100a including terminal pins 98a, which are led through recesses 102a through coil unit 12a and contact terminal areas 96a. A bushing 104a protrudes into recess 54a of electronics unit 36a. In an operational state of inductive charging coil device 10a, plug 100a protrudes into bushing 104a. Plug 100a and bushing 104a form contacting unit 52a. On the side of electronics unit 36a facing toward core unit 48a, a shielding unit 40a, which is formed by a conductive material layer 42a, is situated, which has a projection area 44a which, in the case of a projection in the direction of winding axis 46a of coil unit 12a, covers electronics unit 36a and cell unit 38a. A magnetic alternating field in the area of coil unit 12a is retroreflected in large part in the direction of coil unit 12a by shielding unit 40a, so that a field strength is reduced in the area of cell unit 38a and electronics unit 36a.

To charge cell unit 38a, hand-held power tool rechargeable battery pack 82a is placed on a hand-held power tool device 58a′, which is implemented as a hand-held power tool rechargeable battery charging device 88a′, and which has a similarly constructed inductive charging coil device 10a′. Hand-held power tool rechargeable battery charging device 88a′ has a current supply 70a′. If hand-held power tool rechargeable battery charging device 88a′ is supplied with current, a high-frequency alternating current of 100 kHz flows through inductive charging coil device 10a′, which is generated by charging electronics situated on an electronics unit 36a′. A magnetic alternating field is generated in a coil unit 12a′, which is focused by a core unit 48a′ and emitted essentially in the direction of inductive charging coil device 10a. A current, using which cell unit 38a may be charged, is induced in coil unit 12a of inductive charging coil device 10a.

The following descriptions and the drawings of six additional exemplary embodiments are restricted essentially to the differences between the exemplary embodiments, reference fundamentally being able to be made to the drawing and/or the description of the other exemplary embodiments with respect to identically identified components, in particular in relation to components having identical reference numerals. To differentiate the exemplary embodiments, instead of the letter a of the first exemplary embodiment, the letters b through g are added to the reference numerals of the additional exemplary embodiments.

FIG. 4 shows a hand-held power tool rechargeable battery pack 82b including a coil unit 12b of an inductive charging coil device 10b in a second exemplary embodiment. Inductive charging coil device 10b differs from inductive charging coil device 10a of the first exemplary embodiment in particular in that a core unit 48b is configured as trough-shaped and has a projection area 50b in the direction of a winding axis 46b of coil unit 12b, which covers electronics unit 36b and a cell unit 38b. Due to the trough-shaped configuration, core unit 48b completely encloses electronics unit 36b and partially encloses cell unit 38b around winding axis 46b. Core unit 48b focusses a magnetic alternating field, which impacts core unit 48b from the direction of coil unit 12b, and deflects it in the direction of core unit 48b. A field strength of the magnetic alternating field is particularly low on a side of core unit 48b facing toward electronics unit 36b and cell unit 38b. Electronics unit 36b and cell unit 38b may be protected from an influence of the magnetic alternating field. Coil unit 12b is formed by a circuit board 24b including printed conductors 20b.

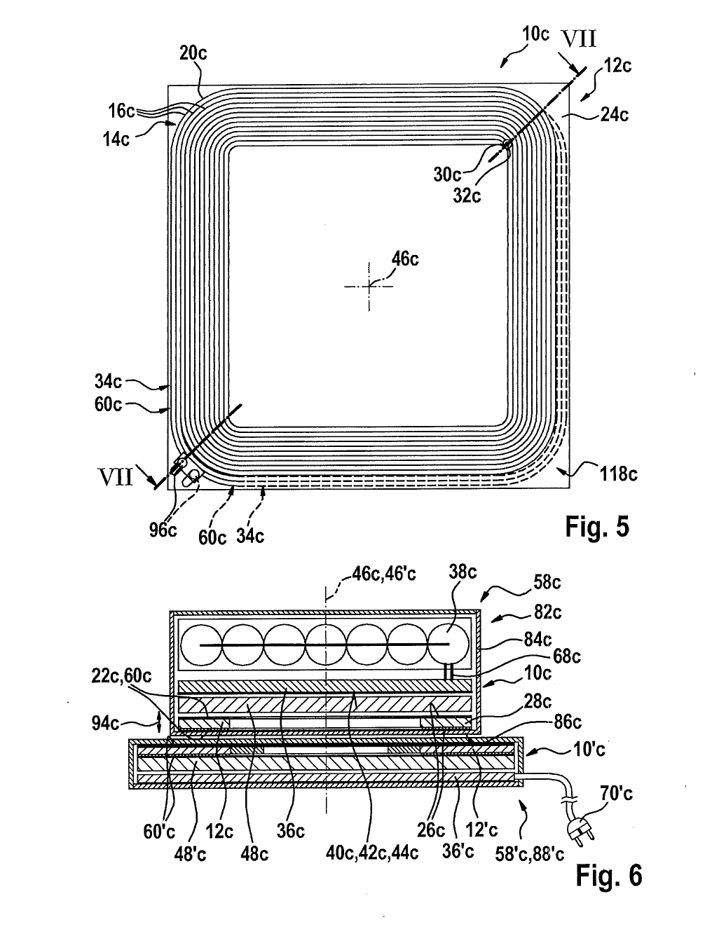

FIG. 5 shows a schematic view of a coil unit 12c of an inductive charging coil device 10c in a third exemplary embodiment. Coil unit 12c has two conductor loops 60c including windings 34c having a winding shape, which deviates from a circular shape and approximates a square having rounded corners 118c.

Windings 34c of conductor loops 60c are formed by printed conductors 20c, which are formed by conductor layers 22c (FIG. 6) of a square circuit board 24c. Conductor layers 22c are situated on two opposing sides 26c of a carrier layer 28c of circuit board 24c. Windings 34c each have one conductor 14c, which, to reduce eddy current losses, has three main cross sections 16c, which are situated in parallel according to line technology, and which are formed by printed conductors 20c. Main cross sections 16c are insulated and sealed using a lacquer layer (not shown in greater detail). Main cross sections 16c end after 5% windings around a winding axis 46c, in relation to a winding axis 46c, on opposing sides of circuit board 24c.

Terminal areas 96c are situated congruently in thickness direction 94c of circuit board 24c. A connecting lead 32c, which is connected to main cross sections 16c, is led through a feedthrough 30c of circuit board 24c. Connecting lead 32c connects ends of windings 34c on the two sides 26c of circuit board 24c. Windings 34c of conductor loops 60c have the same winding direction around winding axis 46c. Both conductor loops 60c have the same number of windings of 5% windings, so that coil unit 12c has in total an odd number of windings of 11.

Inductive charging coil device 10c is an integral part of a hand-held power tool device 58c (FIG. 6). Hand-held power tool device 58c is implemented as a hand-held power tool rechargeable battery pack 82c. A cell unit 38c, which is provided to supply a handheld power tool with energy, is situated in a housing unit 84c. The shape of circuit board 24c and the winding shape of conductor loops 60c are adapted to a base area of a housing wall 86c of housing unit 84c, which is perpendicular to winding axis 46c, and utilize more than 94% of the base area.

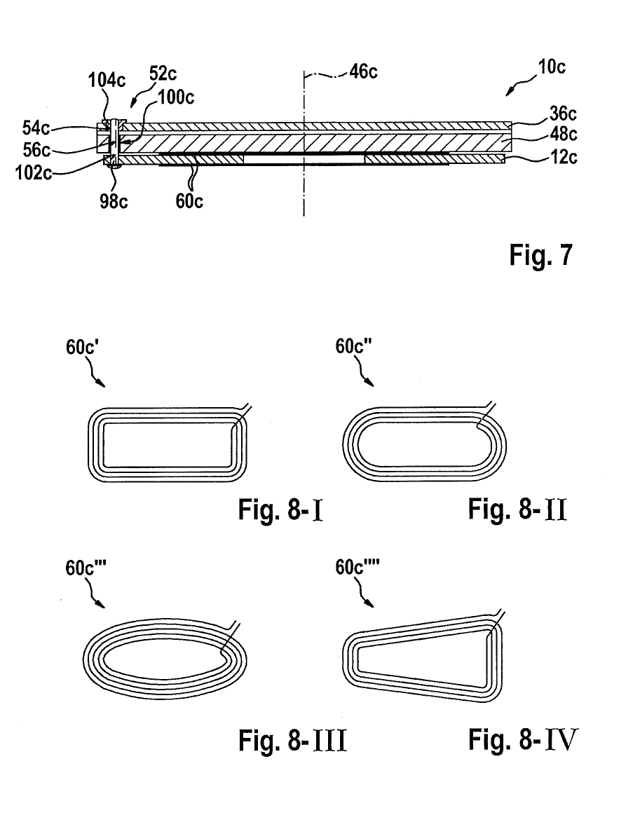

Inductive charging coil device 10c is provided for wireless energy transfer for a charging process of cell unit 38c. Inductive charging coil device 10c is situated between cell unit 38c and housing wall 86c of housing unit 84c. Proceeding from housing wall 86c in the direction of cell unit 38c, coil unit 12c, a core unit 48c, and an electronics unit 36c first follow. Electronics unit 36c is connected with the aid of a connecting lead 68c to cell unit 38c and contains charging electronics, which are provided to charge cell unit 38c. A contacting unit 52c (FIG. 7), which is led through recesses 54c, 56c of electronics unit 36c and core unit 48c, connects electronics unit 36c and coil unit 12c. Contacting unit 52c has a plug 100c including terminal pins 98c, which are led through recesses 102c through coil unit 12c and contact terminal areas 96c. A bushing 104c protrudes into recess 54c of electronics unit 36c. In an operational state of inductive charging coil device 10c, plug 100c protrudes into bushing 104c. Plug 100c and bushing 104c form contacting unit 52c. On the side of electronics unit 36c facing toward core unit 48c, a shielding unit 40c is situated, which is formed by a conductive material layer 42c and has a projection area 44c, which, in the case of a projection in the direction of winding axis 46c of coil unit 12c, covers electronics unit 36c and cell unit 38c. A magnetic alternating field in the area of coil unit 12c is retroreflected in large part in the direction of coil unit 12c by shielding unit 40c, so that a field strength is reduced in the area of cell unit 38c and electronics unit 36c.

To charge cell unit 38c, hand-held power tool rechargeable battery pack 82c is placed on a hand-held power tool device 58′c, which is configured as a hand-held power tool rechargeable battery charging device 88′c, and which has a similarly constructed inductive charging coil device 10′c. Hand-held power tool rechargeable battery charging device 88′c has a current supply 70′c. If hand-held power tool rechargeable battery charging device 88′c is supplied with current, a high-frequency alternating current of 100 kHz, which is generated by charging electronics situated on an electronics unit 36′c, flows through a coil unit 12′c. A magnetic alternating field is generated in coil unit 12′c, which is focused by a core unit 48′c, emitted essentially in the direction of inductive charging coil device 10c, and focused therein by core unit 48c in the area of coil unit 12c. Core units 48c and 48′c have magnetically soft core elements for this purpose, which are cast into a matrix material and formed by a ferrite material. A current is induced in coil unit 12c of inductive charging coil device 10c, using which cell unit 38c may be charged. Conductor loops 60′c of inductive charging coil device 10′c completely cover conductor loops 60c of inductive charging coil device 10c, independently of their orientation around winding axis 46c, in that a smallest winding of conductor loop 60′c has a smallest radius, in its entire circumference around a winding axis 46′c, which is smaller than a smallest radius of conductor loop 60c, and a largest winding of conductor loop 60′c has, in its entire circumference around winding axis 46′c, a largest radius which is larger than a largest radius of conductor loop 60c. The orientation of inductive charging coil device 10c around winding axis 46c in relation to inductive charging coil device 10′c only has a minor influence on an energy transfer.

FIG. 8 shows examples of further alternative winding shapes, which may be used instead of the winding shape approximating a square of coil unit 12c. Those skilled in the art will select a matching winding shape in accordance with a geometry of a housing unit. FIG. 8-I shows a conductor loop 60c′ having a winding shape approximating a rectangle. FIG. 8-II shows a conductor loop 60c″ having a winding shape which approximates two semicircles including two linear side edges. FIG. 8-III shows a conductor loop 60c′″ having a winding shape approximating an oval. FIG. 8-IV shows a conductor loop 60c″″ having a winding shape approximating a trapezoid.

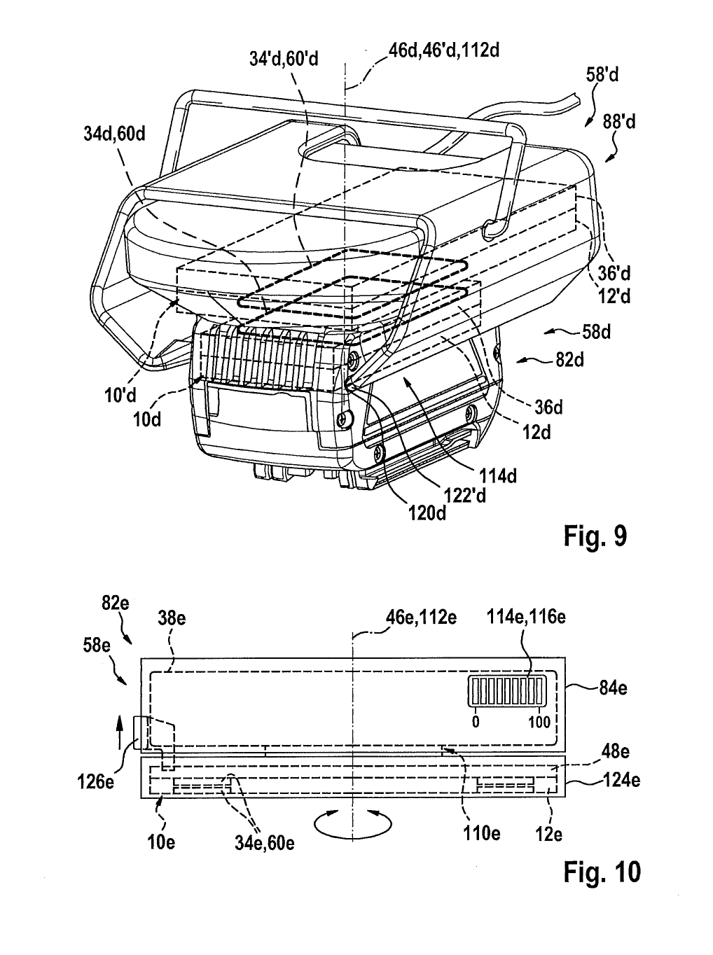

FIG. 9 shows a system including two hand-held power tool devices 58d and 58′d, which are implemented as handheld power tool rechargeable battery 82d and hand-held power tool rechargeable battery charging device 88′d having inductive charging coil devices 10d and 10′d situated in their interior, which contain coil units 12d and 12′d, in a fourth exemplary embodiment. Hand-held power tool devices 58d and 58′d differ from the third exemplary embodiment in particular due to an alignment unit 114d, which is provided to align a coil unit 12d of inductive charging coil device 10d in an orientation around at least one axis 112d. Hand-held power tool rechargeable battery pack 82d has guide grooves 120d, using which it is inserted for charging a cell unit (not shown in greater detail here) of hand-held power tool devices 58d into guide rails 122′d of hand-held power tool rechargeable battery charging device 88′d. Guide grooves 120d and guide rails 122′d form alignment unit 114d, which is provided to align inductive charging coil devices 10d and 10′d in an orientation around axis 112d, which is formed by winding axes 46d and 46′d, in relation to one another. Alignment unit 114d also establishes the orientation of hand-held power tool rechargeable battery pack 82d in relation to hand-held power tool rechargeable battery charging device 88′d around the further rotational degrees of freedom and two translational degrees of freedom. Coil units 12d, 12′d have windings 34d, 34′d, which are formed similarly to the third exemplary embodiment by conductor loops 60d, 60′d, and electronics units 36d, 36′d.

FIG. 10 shows a hand-held power tool device 58e, which is implemented as a hand-held power tool rechargeable battery pack 82e and has an inductive charging coil device 10e, in a fifth exemplary embodiment. Inductive charging coil device 10e differs from inductive charging coil device 10c of the third exemplary embodiment in particular due to a coil bearing unit 110e, which is provided to rotatably support inductive charging coil device 10d including a coil unit 12e around an axis 112e, which is implemented as winding axis 46e of windings 34e formed by conductor loops 60e. Inductive charging coil device 10e has a coil housing 124e, in which coil unit 12e and a core unit 48e are situated. Coil housing 124e is rotatably supported together with coil bearing unit 110e on a housing unit 84e of hand-held power tool rechargeable battery pack 82e around winding axis 46e of coil unit 12e. A locking element 126e is used to fix coil housing 124e in a base position. A display unit 116e is situated on hand-held power tool rechargeable battery pack 82e, which signals a quality of an alignment of coil unit 12e around axis 112e to a user during a charging process. Display unit 116e therefore forms an alignment unit 114e. Display unit 116e indicates the quality in steps between 0% and 100%. The user may unlock locking element 126e and rotate coil housing 124e until an optimum quality is achieved. If hand-held power tool rechargeable battery pack 82e is used for operating a handheld power tool, display unit 116e alternatively indicates a charge state of a cell unit 38e of hand-held power tool rechargeable battery pack 82e to the user.

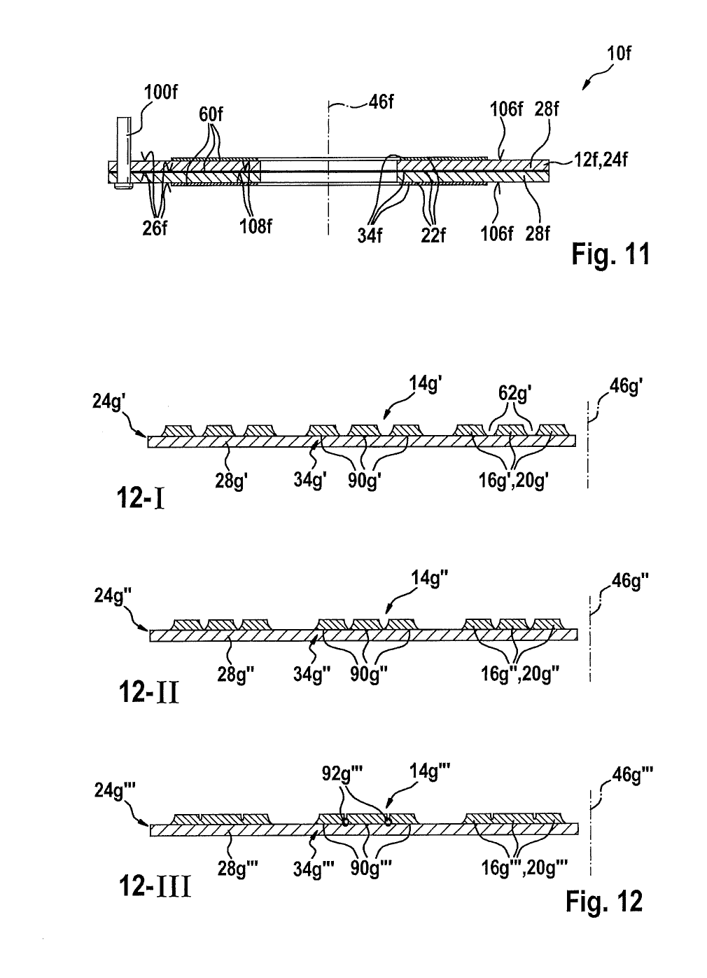

FIG. 11 shows a coil unit 12f of an inductive charging coil device 10f in a sixth exemplary embodiment. Coil unit 12f is formed by a circuit board 24f. Inductive charging coil device 10f differs from inductive charging coil device 10a of the first exemplary embodiment in particular in that circuit board 24f has a multilayered structure including two carrier layers 28f. Circuit board 24f has three conductor loops 60f situated on sides 26f of carrier layers 28f. Two conductor loops 60f are situated on sides 26f, which form outer sides 106f, of carrier layers 28f of circuit board 24f, and a third conductor loop 60f is situated between two sides 26f, which form inner sides 108f, of carrier layers 28f. The three conductor loops 60f are formed by three conductor layers 22f of circuit board 24f. Two feedthroughs (not shown in greater detail here) having connecting leads connect conductor loops 60f. A plug 100f is provided for contacting coil unit 12f as in the preceding exemplary embodiment. Coil unit 12f has a greater number of conductor loops 60f in comparison to the first exemplary embodiment and may therefore in total have a greater number of windings 34f around a winding axis 46f. Coil unit 12f is used in inductive charging coil device 10f similarly to the first exemplary embodiment.

FIG. 12 shows further possible main cross sections 16g′-g′″ of conductors 14g′-g′″ of further coil units (not shown in greater detail in this example) of further inductive charging coil devices. Main cross sections 16g′-g′″ shown may be used similarly in all exemplary embodiments. Main cross sections 16g′-g′″ are formed by printed conductors 20g′-g′″ of a circuit board 24g′-g′″ and have a trapezoidal shape, a trapezoid base 90g′-g′″ being oriented in the direction of a carrier layer 28g′-g′″ of circuit board 24g′-g′″.

FIG. 12-I shows a conductor 14g′, whose main cross sections 16g′ are situated separated in the direction of a radius around a winding axis 46g′ from windings 34g′ at a distance of intermediate spaces 62g′. Main cross sections 16g′ are completely separated along intermediate spaces 62g′ and are electrically insulated in relation to one another. This corresponds to conductors 14a, 14b shown in the first and second exemplary embodiments.

FIG. 12-II shows a conductor 14g″, whose main cross sections 16g″ are situated touching, in contrast to main cross sections 16g′. Main cross sections 16g″ each touch on outer edges of their trapezoid base 90g″. Main cross sections 16g″ may thus be situated particularly compactly. In the direction of a radius around a winding axis 46g″, adjacent main cross sections 16g″ have no mutual material cross sections along windings 34g″. Therefore, no or only minor current flows take place between adjacent main cross sections 16g″. Conductor 14g″ has a particularly compact arrangement of main cross sections 16g″ with an identical overall cross section.

FIG. 12-III shows a conductor 14g′″, whose trapezoidal main cross sections 16g′″ are situated sufficiently close in the direction of a radius around a winding axis 46g′″ of windings 34g′″ that they are connected to one another in a connection area 92g′″ at their trapezoid bases 90g′″. Due to the skin effect, which forces high-frequency currents to the conductor surface, current flows between adjacent main cross sections 16g′″ are low in the case of high-frequency currents. Conductor 14g′″ has a still more compact arrangement of main cross sections 16g′″ with an identical overall cross section.

1-11. (canceled)

12. An inductive charging coil device, comprising:
at least one coil unit having at least one conductor;
wherein the conductor includes at least two main cross sections.

13. The inductive charging coil device of claim 12, wherein adjacent main cross sections of the at least one conductor are situated so as to be touching and/or adjacent main cross sections of the at least one conductor are connected to one another.

14. The inductive charging coil device of claim 12, wherein adjacent main cross sections of the at least one conductor are situated so as to be separated by insulators.

15. The inductive charging coil device of claim 12, wherein the coil unit is at least partially formed by printed conductors of at least one conductor layer of a circuit board.

16. The inductive charging coil device of claim 15, wherein the coil unit is at least partially situated on two conductor layers of the circuit board.

17. The inductive charging coil device of claim 15, wherein the circuit board includes at least one feedthrough, through which at least one connecting lead of the coil unit is led.

18. The inductive charging coil device of claim 12, wherein there are a number of windings of two conductor loops which are odd in total.

19. The inductive charging coil device of claim 12, wherein there are at least largely congruently situated terminal areas of the coil unit in a thickness direction of the circuit board.

20. The inductive charging coil device of claim 12, further comprising:
at least one of an electronics unit and a core unit, and a contacting unit for contacting the coil unit, the contacting unit being led through a recess of the electronics unit and/or the core unit.

21. The inductive charging coil device of claim 12, wherein the coil unit includes at least one winding having a winding shape deviating from a circular shape.

22. The inductive charging coil device of claim 12, wherein the inductive charging coil device includes a hand-held power tool inductive charging coil device.

23. A hand-held power tool device, comprising:
an inductive charging coil device, including at least one coil unit having at least one conductor, wherein the conductor includes at least two main cross sections.
